(19) United States
(12) Patent Application Publication
(10) Pub. No.: US 2014/0176445 A1
(43) Pub. Date: Jun. 26, 2014

(54) GRAPHICAL USER INTERFACE DRIVEN KEYBOARD CONFIGURATION

(71) Applicant: GENERAL ELECTRIC COMPANY, Schenectady, NY (US)

(72) Inventors: Andrew David Stonefield, Wauwatosa, WI (US); Jonathan A. Bowman, Montgomery, AL (US)

(73) Assignee: GENERAL ELECTRIC COMPANY, Schenectady, NY (US)

(21) Appl. No.: 13/727,026

(22) Filed: Dec. 26, 2012

(51) Int. Cl. G06F 3/02

(52) U.S. Cl. CPC G06F 3/02
USPC 345/168

(57) ABSTRACT

A method and apparatus modify at least one characteristic of a physical keyboard based on the modifications to a display of the one or more graphical user interfaces on a display screen.

### BACKGROUND

Electronic devices utilize graphical user interfaces to facilitate the input of data, selections or commands. Touch screens are sometimes used for selecting a presented graphical user interface. However, touch screens may not readily allow a person to hover over a graphical user interface and may be ergonomically uncomfortable to use for prolonged periods of time. Keyboards, also known as keypads, are also sometimes used for selecting a presented graphical user interface. However, such keyboards may have a large array of keys, making it difficult to locate the correct key or groups of keys when selecting a graphical user interface.

### BRIEF DESCRIPTION OF THE DRAWINGS

FIG. 1 is a schematic illustration of an example keyboard control system.

FIG. 2 is a flow diagram of an example keyboard control method that may be carried out by the system of FIG. 1.

FIG. 3 is a schematic illustration of an example implementation of the keyboard control system of FIG. 1 having a first display of graphical user interfaces and a first keyboard configuration.

FIG. 4 is a schematic illustration of the keyboard control system of FIG. 3 having a second display of graphical user interfaces and a second keyboard configuration.

FIG. 5 is a fragmentary sectional view schematically illustrating another example implementation of the keyboard control system of FIG. 1.

FIG. 6 is a top view of the keyboard control system of FIG. 5.

FIG. 7 is a diagram illustrating an example implementation of the keyboard control system of FIG. 5 having a first display of graphical user interfaces and a first corresponding keyboard configuration.

FIG. 8 is a diagram illustrating the keyboard control system of FIG. 5 having a second display of graphical user interfaces and a second corresponding keyboard configuration.

FIG. 9 is a top view of an example keyboard for use in the keyboard control system of FIGS. 1, 3, 5 and 7.

### DETAILED DESCRIPTION OF THE EXAMPLE EMBODIMENTS

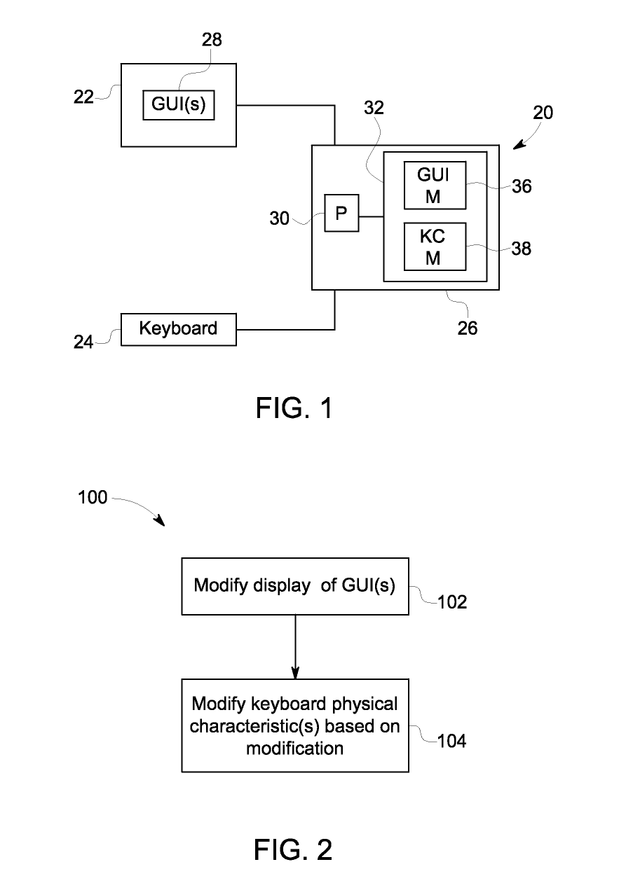

FIG. 1 schematically illustrates an example keyboard control system 20. As will be described hereafter, keyboard control system 20 dynamically modifies one or more configuration characteristics of a keyboard based upon modifications being made to a display of graphical user interfaces. Keyboard control system 20 modifies the one or more configuration characteristics of the keyboard such that a person may more easily locate keys or other inputs to select one or more of the graphical user interfaces being displayed.

Keyboard control system 20 comprises display 22, keyboard 24 and controller 26. Display 22 comprises a screen by which graphics, data, video and the like may be visually presented to a person. Display 22 may be provided as part of a desktop computer monitor, a television, a smart phone, a personal data assistant, flash memory player, a medical monitor and the like. Display 22 is configured to display one or more graphical user interfaces 28 for selection by a person. The displayed one or more graphical user interfaces are selectable by inputs made to keys of keyboard 24. In some implementations, in addition to being selectable by inputs made to keys of keyboard 24, the one or more displayed graphical user interfaces may additionally be selected by a person physically touching display 22 (comprising a touch screen) at a location over or corresponding to the displayed graphical user interface 28 or by a person locating a cursor (such as with an arrow key on keyboard 24, a mouse, a touchpad, stylus or the like) to a location over or corresponding to the displayed graphical user interface.

Keyboard 24 comprises a physical board, pad, panel or the like providing keys for inputting data, commands and selections. Keyboard 24 comprises a plurality of keys, wherein the individual keys are configured to be selected by being depressed, touched or otherwise interacted upon. Individual keys of keyboard 24 may be individually selected to individually select certain graphical user interfaces 28 presented on display 22. In one implementation, keyboard 24 may comprise a QWERTY keyboard comprising alphanumeric symbols. In another implementation, keyboard 24 may comprise a keyboard or keypad having a plurality of keys having other types of keys, other numbers of keys and other layouts of keys. In one implementation, the individual keys of keyboard 24 have a fixed size, a fixed shape and are relatively fixed in location with respect to one another. In one implementation, the individual keys and keyboard 24 comprise projections or protuberances projecting from an underlying substantially flat region about such keys, wherein the projecting portions of such keys are resiliently depressable to trigger the transmission of a signal to a processing unit indicating the selection of the key. In another implementation, such keys may be provided as part of a holographic image or may be provided as part of a panel having depressable or touch sensitive portions or regions corresponding to the keys, wherein the size and location of such keys is fixed so as to not change despite changes to information or graphical user interfaces being presented on display 22.

Controller 26 controls the operation of at least keyboard 24. Controller 26 controls one or more configuration characteristics of keyboard 24 based upon how one or more graphical user interfaces 28 are being presented on display 22 and how the display of such one or more graphical user interfaces is being altered or modified. For example, a first display or presentation of graphical user interfaces upon display screen 22 may present graphical user interfaces in a first arrangement or layout that may be changed or modified to a second display or presentation of graphical user interfaces having a different layout. In addition to the layouts of the graphical user interfaces being changed, the individual graphical user interfaces in the first and second displays may also be changed. Based upon such changes, one or more configuration characteristics of keyboard 24 is modified. In one implementation, the configuration characteristic of keyboard 24 that is changed by controller 22 is the assignment of individual keys to the graphical user interface is being momentarily are currently presented on the display screen. In particular, controller 26 may assign keys to the graphical user interfaces such that those keys that are assigned have a layout, collective shape or arrangement that correlates to, matches or mimics the layout, collective shape or arrangement of graphical user interfaces being presented on the display screen. In other implementations, the configuration characteristic of keyboard 24 that is modified by controller 26 is a physical configuration characteristic of keyboard 24. For purposes of this disclosure, a change to a “physical” configuration characteristic is a change to a characteristic of keyboard 24 that is physically discernible with respect to keyboard 24 itself independent of what may be presented upon display screen 22. For example, a change in lighting or a change in color of a key or region surrounding a key is physically discernible independent of what is being displayed on display screen 22. A change in the amount of pressure to activate a key of the keyboard or the height of the key is physically discernible independent of what is being displayed on the display screen 22. A change in the sound produced (or not produced) by selection or depressment of a key is physically discernible independent of what is being displayed on the display screen.

In one implementation, controller 26 additionally changes a physical characteristic of keyboard 24 based upon changes to the display of graphical user interfaces 28 on display screen 22 by highlighting certain keys of keyboard 24 or by changing the operation of certain keys. In one implementation, controller 26 controls the both the presentation of graphical user interfaces 28 on display 22 and one or more physical configuration characteristics of keyboard 24. In another implementation, controller 26 senses or receives signals indicating how the display of graphical user interfaces on display 22 is being presented and modified.

As shown by FIG. 2, controller 26 comprises processing unit 30 and memory 32. Processing unit 30 comprises one or more processing units configured to carry out instructions contained in memory 32. For purposes of this application, the term “processing unit” shall mean a presently developed or future developed processing unit that executes sequences of instructions contained in a memory, such as memory 32. Execution of the sequences of instructions causes the processing unit to perform steps such as generating control signals. In other embodiments, hard wired circuitry may be used in place of or in combination with software instructions to implement the functions described. For example, controller 26 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 32 comprises a non-transient computer-readable medium or persistent storage device for storing programming, code or instructions for processor 30. In some implementations, memory 32 may also store data. Examples of memory 32 include, but are not limited to a random access memory (RAM) a read only memory (ROM), a mass storage device, or some other persistent storage.

In the example illustrate, memory 32 comprises graphical user interface module 36 and keyboard control module 38. Modules 36 and 38 comprise programming stored in memory 32 for directing processor 30 to carry out particular actions. Graphical user interface module 36 comprise instructions for directing processor 30 to generate control signals to direct the presentation of one or more graphical user interfaces 28 on display screen 22. In one implementation, module 36 causes processor 32 generate control signals presenting graphical user interfaces 28 having shapes and sizes corresponding to shapes and sizes of keys of keyboard 24. In other implementations, module 36 may be contained in a separate memory or may direct a separate processing unit to generate and display graphical user interfaces 28 on display screen 22, wherein controller 26 merely receive signals indicating how the graphical user interfaces 28 are being presented on display screen 22.

Keyboard control module 38 comprise instructions for directing processor 32 modify one or more configuration characteristics of keyboard 24 based upon changes to the way graphical user interface 28 are being presented on display screen 22 and/or based upon what graphical user interfaces 28 are being presented on display screen 22. As noted above, based upon changes to the display of graphical user interfaces 28 on display screen 22, key control module 38 may direct processor 32 generate control signals assigning keys to the graphical user interfaces being presented such that the keys have a layout corresponding to the layout of the graphical user interface is being presented. based upon changes to the display of graphical user interfaces 28 on display screen 22, key control module 38 may direct processor 32 generate control signals causing certain keys of keyboard 24 to be highlighted or the operation of certain keys to be altered. When the display of graphical user interfaces 28 changes once again, the configuration characteristics of keyboard 24 are once again is changed. As a consequence, the same key of keyboard 24 may be assigned to a first graphical user interface for inputting a first command or selection in the first display being presented in a program and may be assigned to a completely different second graphical user interface for inputting a different second commander selection in a second display being presented by the same program. Even though the assignment of keys to graphical user interfaces may change from display (screenshot) to display (screenshot) in the same program or the same application, any user confusion is reduced because the layout of graphical user interfaces and the display drive and determine the assignment of keys to graphical user interfaces such that the keys and graphical user interfaces have corresponding or mimicking layouts. As a result, system 20 provides a dynamically changing keyboard that dynamically changes based upon the momentary display of graphical user interfaces 28 being presented, wherein the dynamic changes to keyboard 24 facilitate location and selection of those keys of keyboard 24 that are assigned to the graphical user interfaces being presented, enhancing the ease at which a person may select a graphical user interface and display screen 22 using the keys of keyboard 24.

FIG. 2 is a flow diagram illustrating an example method 100 that may be carried out by system 20 for controlling a keyboard. As indicated by step 102, the display of graphical user interfaces 28 and display 22 is modified. In some implementations, controller 26 may generate control signals causing the display of graphical user interfaces 28 on display screen 22 to be modified. In another implementation, other separate or independent controllers may be causing the display of graphical user interfaces 28 and display screen 22 to be modified. The display of graphical user interface may be modified in that the layout arrangement of graphical user interfaces is changed and/or in that the individual graphical user interfaces themselves are changed.

As indicated by step 104, controller 26 modifies one or more configuration characteristics of keyboard 24 based upon the modifications to the display of graphical user interfaces in step 102. As noted above, such modifications to keyboard 24 may comprise the assignment of keys to graphical user interfaces so as to produce layout that mimic one another. Such modifications a keyboard 24 may further comprise the highlighting of individual keys of keyboard 24, the highlighting of subsets of keys 24 or groupings of keys 24, or the modification of the operation of keys 24. For example, highlighting may be achieved by providing backlighting or by writing particular colors to backlighting with respect to the keys themselves or services or regions about such keys. The operation of individual keys are groups of keys may be modified by adjusting the pressure sensitivity, the height of such keys (by raising or lowering keys) or the texture of such keys. In another implementation, the operation of individual keys or groups of keys may be modified by rendering such individual keys or groups of keys inoperable such as with a lockout mechanism that prevents depressment of such keys (lockout rigidity), by adjusting the pressure sensitivity of such keys or by disabling signal transmission from such keys using a switch

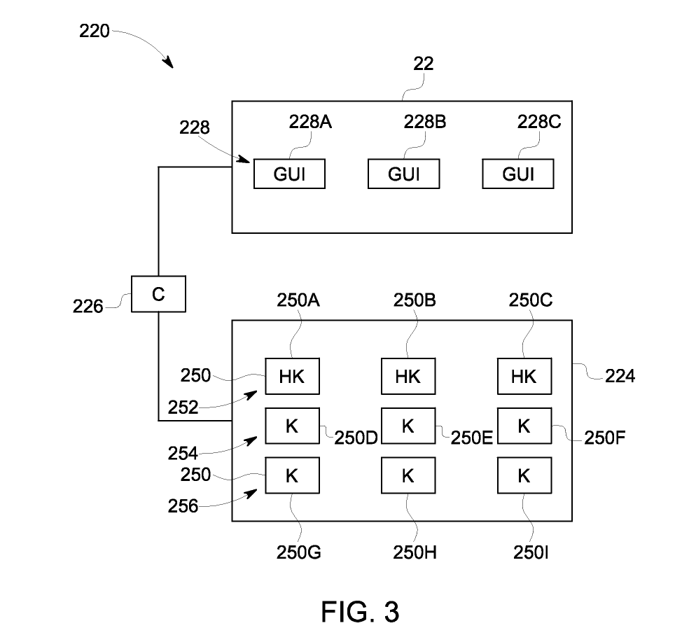

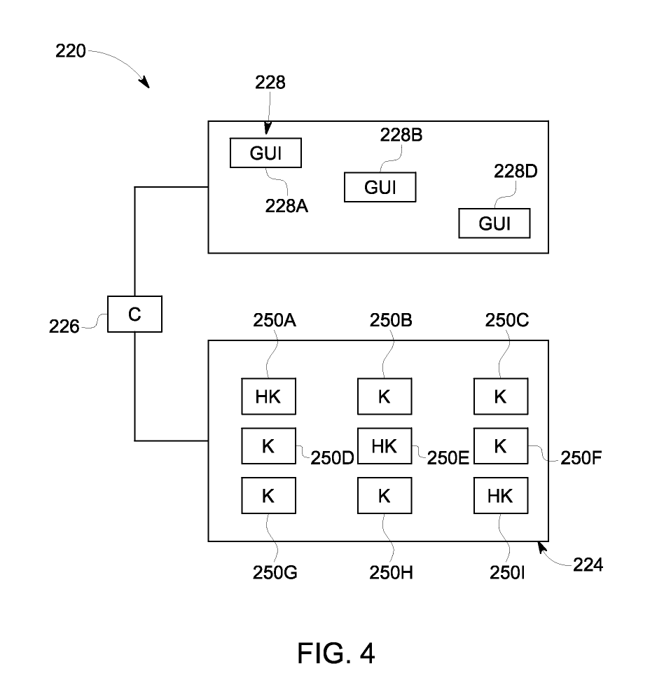

FIGS. 3 and 4 schematically illustrate keyboard control system 220, an example implementation of keyboard control system 20. Keyboard control system 220 is similar to system 20 except that system 220 specifically comprises keyboard 224 and controller 226, example implementations of keyboard 24 and controller 26, respectively. Keyboard 224 comprises a physical board, pad, panel or the like providing keys for inputting data, commands and selections. Keyboard 224 comprises a plurality of keys 250, wherein the individual keys. 50 are configured to be selected by being depressed, touched or otherwise interacted upon. Individual keys of keyboard 224 may be individually selected to individually select certain graphical user interfaces presented on display 22. In the example illustrated, keyboard 224 is illustrated as comprising a two dimensional 3×3 array or grid of keys 250, wherein the location of keys 250 relative to one another is predefined and fixed. Although not illustrated, keyboard 224 may include additional keys not shown. In other implementations, keyboard 224 may have greater or fewer of keys 250 and the same or different arrangement or layout.

Controller 226 is similar to controller 26 except that key control module 38 open shown FIG. 1) of controller 226 is specifically configured to direct processor 30 (1) to assign specific keys 250 to graphical user interfaces 228 and (2) to also highlight keys 250 of keyboard 24 based upon the layout of graphical user interfaces 228 and display screen 22. In particular, keyboard control module 38 of controller 226 cause the processor 30 to generate control signals such individual keys 250 are assigned to graphical user interfaces 228 in a way such that the layout of keys 250 assigned to graphical user interface 228 correspond to, at least closely match or mimic a layout of the graphical user interface 228 being presented on display screen 22. In some implementations, the assignment of keys 250 to graphical user interface 228 may be initially made by the application producing the graphical user interfaces, wherein controller 226 alter or modifies the original or default key assignments. In some implementations, the application or program itself may assign keys to graphical user interfaces in a fashion such that the layout of the assign keys mimics the layout of the graphical user interfaces being presented on the display screen 22. In those implementations where the application or program has already assigned keys to graphical user interfaces such that the layouts mimic one another, controller 226 may enhance use of keyboard 24 by adding highlighting changes or operational control changes to the keys without any further key-to-graphical user interface assignment changes.

In the example implementation shown in FIGS. 3 and 4, those keys 250 that are assigned to graphical user interface 228 are highlighted. In one implementation, the keys may be highlighted in a fashion so as to also mimic the graphical user interfaces 228 being presented on display screen 22. For example, keys 250 assigned to graphical user interfaces 228 may be highlighted using colors that mimic or correspond to the colors of the graphical user interfaces 228 being displayed. For example, graphical user interfaces 228A, 228B and 228C may have the colors red, green and blue. In such a scenario, keys 250A, 250B and 250C may be correspondingly highlighted with red, green and blue colors, respectively, either through colored backlighting to the keys themselves or color backlighting to regions about such keys. As a result, a person may quickly and easily locate those keys that are assigned to the graphical user interface 228 in a clear and intuitive manner.

By way of example, FIG. 3 illustrates a scenario wherein three graphical user interfaces 228A, 228B and 228C (collectively referred to as graphical user interface 228 are being momentarily presented on display screen 22, until one of the graphical user interfaces to 28 is selected or until a predetermined time has elapsed. Interfaces 228 are arranged in a single horizontal row. As a result, keyboard control module 38 of controller 226 correspondingly assigns three individual keys, also arranged in a single horizontal row, to the three graphical user interfaces 228. In the example illustrated, keyboard control module 38 of controller 226 assigns keys 250A, 250B and 250C to graphical user interfaces to 228A, 228B and 228C, respectively. As there is only a single row of graphical user interfaces 228 being presented, in other implementations, controller 226 could alternatively assign the keys 250 contained in rows 252 or 256 to graphical user interface 228.

In the example illustrated, as further indicated by the designation “HK”, keyboard control module 38 of controller 26 additionally highlights those keys 250 assigned to graphical user interface 228. Alternatively, the particular operational characteristics of those keys 250 assigned to graphical user interface 228 may be modified. In other implementations, the additional highlighting or operational modification of those keys assigned to graphical user interface 228 may be omitted or maybe optional (selectable in a settings mode for system 20).

FIG. 4 illustrates the same keyboard control system 220, wherein the display of graphical user interfaces 228 on display screen 22 has been changed or modified. For example, such modification may be in response to an application or program prompting for different inputs, selections are commands as represented by different graphical user interfaces or graphical user interfaces be presented at different locations on screen 222. In the scenario shown in FIG. 4, graphical user interfaces 228A, 228B and 228D are being presented in a generally diagonal layout, pattern or arrangement.

In response to the change in the layout of graphical user interfaces 228 on display screen 222, keyboard control module 38 of controller 226 correspondingly makes changes to the assignment of keys 250 to graphical user interfaces 228 and additionally changes the highlighting of such assigned keys 250. Example illustrated, keyboard control module 38 of controller 226 assigns three individual keys, also arranged in a diagonal pattern or layout corresponding to the diagonal layout of graphical user interfaces 228, to the three graphical user interfaces 228. In the example illustrated, keyboard control module 38 of controller 226 assigns keys 250A, 250E and 250I to graphical user interfaces to 228A, 228B and 228D, respectively.

In the example illustrated, as further indicated by the designation “HK”, keyboard control module 38 of controller 26 additionally highlights those keys 250A, 250E and 250I assigned to graphical user interface 228. Alternatively, the particular operational characteristics of those keys 250 assigned to graphical user interface 228 may be modified. In other implementations, the additional highlighting or operational modification of those keys assigned to graphical user interface 228 may be omitted or maybe optional (selectable in a settings mode for system 20).

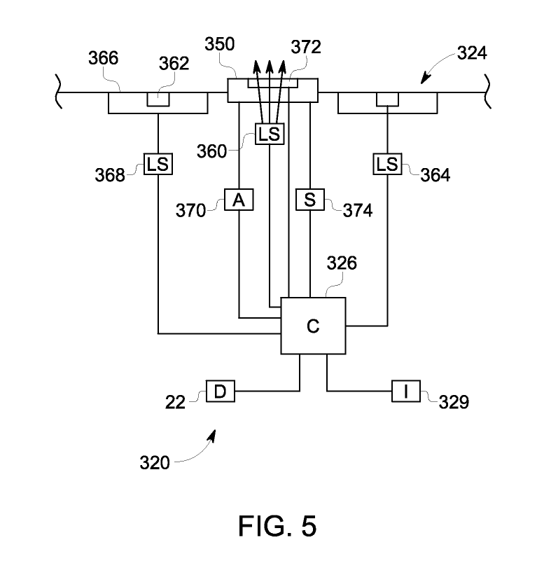

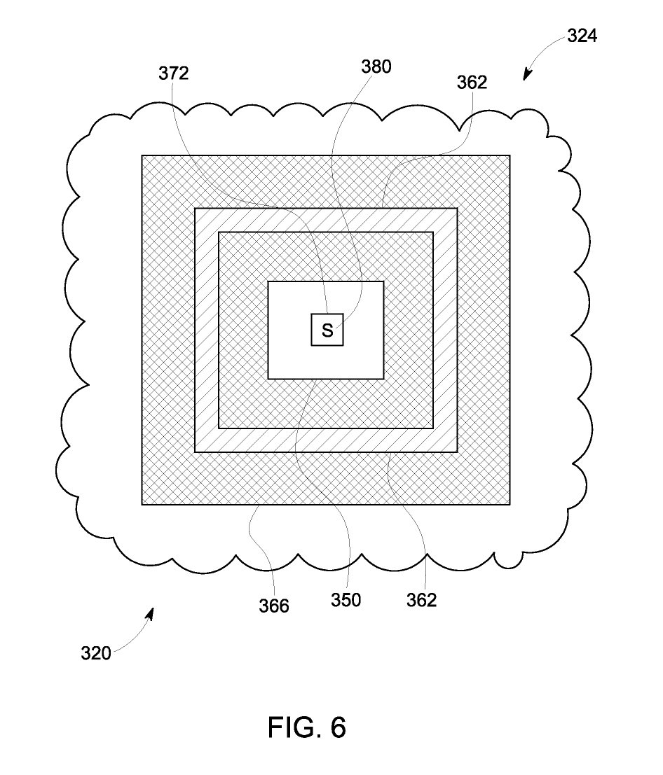

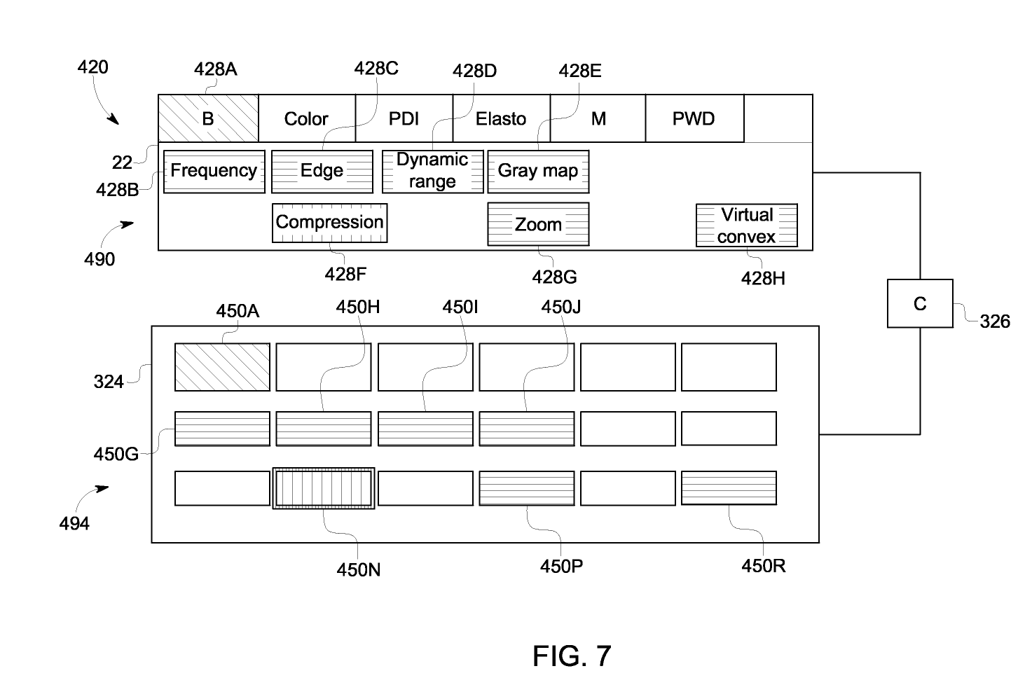

FIGS. 5 and 6 schematically illustrate keyboard control system 320, an example implementation of keyboard control system 20 (or keyboard control system 220). As shown by FIG. 5, keyboard control system 320 is similar to keyboard control system 220 except the keyboard control system 320 specifically comprises keyboard 324 and controller 326 in lieu of keyboard 224 and controller 226, and further comprises input 329. FIG. 5 is a fragmentary sectional view illustrating a portion of keyboard 324, illustrating an individual key 350 and surrounding portions of keyboard 324. Although FIG. 5 illustrates an individual key 350 for purposes of illustration, keyboard 324 comprises a plurality of keys, such as an array or grid of keys 350 similar to that shown in FIG. 3, wherein each of the keys 350 may be identical to the key 350 shown in FIG. 5.

As shown by FIG. 5, in addition to key 350, keyboard 324 comprises a light source 360, illumination line 362, light source 364, illumination panel 366, light source 368, actuator 370, key display 372 and switch 372. In the example illustrated, key 350 is at least partially formed from one or more materials so as to have at least one transparent or translucent portion through which light from light source 364 may pass for backlighting key 350. Light source 360 comprises a source of light to direct light through or backlight key 350. In one implementation, light source 360 is configured be actuated between and on and off state, wherein highlighting of key 350 is performed by actuating light source 360 to one of the on and off states different than those keys that are not being highlighted. In one implementation, light source 360 is configured to be selectively actuated to emit different colors of light. For example, light source 360 may comprise a plurality of selectively and independently actuatable light emitting diodes (with or without color producing filters) that produce different colors of light, wherein highlighting of key 350 is performed by selectively actuating light source 360 to emit a particular color of light, wherein those keys that are not being highlighted are backlit with a different color or are not backlit. In some implementations, highlighted keys 350 may be backlit and non-highlighting keys 350 may not be backlit, wherein the backlit highlighting keys 350 are backlit with different colors corresponding to the different colors of graphical user interfaces 228 assigned to the individual keys. In one implementation, light source 360 is selectively actuatable between different brightness states and/or different pulsing frequencies, wherein highlighting of key 350 is performed by distinguishing key 350 from non-highlighted keys 350 by providing key 350 with a different brightness or a different pulse frequency. In one implementation, light source 360 is configured to be selectively actuatable between each of the aforementioned states (on-off, color, brightness, pulse frequency), wherein the user may select one or more of the aforementioned states for use in highlighting.

Illumination line 362 comprises a bar, rod, wire of material provided in a platform region of keyboard 324 adjacent to and about key 350, from which key 350 may project, wherein the material is configured to transmit and emit light produced by light source 364. In one implementation, illumination line 362 may comprise a light pipe, such as a transparent or translucent acrylic material, configured to emit light in an upward direction away from keyboard 324 were being seen by a person using keyboard 324. As shown by FIG. 6, in the example illustrated, illumination line 362 surrounds key 350. In other implementations, illumination line 362 may have other configurations or shapes, such as where line 362 forms a word, symbol or the like.

Light source 364 is similar light source 370. Light source 364 is configured to be actuatable between different states (on-off, color, brightness, pulse frequency) depending upon a selected highlighting mode to highlight the associated key 350. In one implementation, light source 364 generates light which is distributed by the material of illumination line 362. In another implementation, light source 364 may be incorporated as part of illumination line 362.

Illumination panel 364 comprises plate or wall of material provided in a platform region of keyboard 324 adjacent to and about key 350, from which key 350 may project, wherein the material is configured to transmit and emit light produced by light source 364. In one implementation, illumination panel 366 may comprise a light pipe, such as a transparent or translucent acrylic material, configured to emit light in an upward direction away from keyboard 324 so as to be visible to a person using keyboard 324. As shown by FIG. 6, in the example illustrated, illumination panel 366 surrounds key 350. In other implementations, illumination line 362 may have other configurations or shapes. In some implementations, illumination panel 366 may continuously extend about a group of multiple keys 350, wherein panel 366 facilitates highlighting of a group of keys 350 collectively.

Light source 368 is similar light source 360. Light source 368 is configured to be actuatable between different states (on-off, color, brightness, pulse frequency) depending upon a selected highlighting mode to highlight the associated key 350. In one implementation, light source 368 generates light which is distributed by the material of illumination panel 366. In another implementation, light source 368 may be incorporated as part of illumination panel 366.

Actuator 370 comprises a powered mechanism (such as a solenoid, piezoresistive actuator, and the like) operably coupled to key 350 to physically alter a mode of operation of key 350. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

In one implementation, actuator 370 is configured to raise or lower key 350 to alter its height with respect to the surrounding platform, wherein the highlighting of key 350 is performed by providing key 350 with a distinct height (such as being elevated) relative to other keys 350 that are not being highlighted. In another implementation, actuator 370 is configured to lock key 350 against movement or against depressment when key 350 is not being highlighted, inhibiting its actuation or selection. Because key 350 is locked against movement, in contrast to those keys 350 which are being highlighted by being still permitted to be depressed, the person can tactility determine whether the particular key 350 is one of the keys assigned to the graphical user interfaces being presented. In yet another implementation, actuator 370 may be configured to alter a level of resistance applied to key 350 against movement or depressment of key 350, wherein keys assigned to graphical user interfaces are distinguished from those keys not assigned to graphical user interfaces based upon different levels of resistance applied by each actuator 372 the respective key 350. For example, in one implementation, actuator 370 may just positioning of the one or more resilient structures, such as springs, supporting key 3 and 52 adjust depressment resistance. In one implementation, actuator 370 may include multiple mechanisms, were in actuator 370 is configured to selectively modify the operation of key 350 in any of the aforementioned fashions depending upon the particular mode selected by the person using keyboard 324.

Key display 372 comprises a selectively actuatable display carried by key 350 which is actuatable to present different alphanumeric symbols, graphics and the like in response to control signals from controller 326. For example, key display 372 may comprise a liquid crystal display similar to those found in handheld calculators. Key display 372 may be controlled to present a similar graphic different from other keys so as to highlight and distinguish the associated key 350 from other keys, such as when the associated key 350 is assigned to a graphical user interface 228 or the other keys are not. In some implementations, keys assigned to graphical user interface may be provided with a graphic by key display 372 while keys not assigned are not provided with a graphic, wherein those keys assigned to graphical user interface have different graphics or symbols on their associated key displays 372 and wherein such graphics or symbols correlate or are otherwise linked to the particular graphical user interface assigned to the particular key. For example, the graphical user interface 228 may include a first symbol, wherein the particular key 250 may have a corresponding symbol presented by display 372.

Switch 374 comprises a switch, under the control of controller 326, that deactivates the transmission of signals from key 350. In other words, selection or depressment of key 3 and 50 does not result recognition of the selection or depressment by the programmer application. For example, those keys that are not assigned to any graphical user interfaces may be deactivated by switch 374 such that any accidental depressment of such unassigned keys is ignored.

Controller 326 is similar to controller 226 except that controller 326 is specifically configured to modify the physical configuration of keyboard 324 based upon characteristics of the graphical user interfaces being presently displayed on a display screen 22 using one or more of the above-described mechanisms or components. Controller 326 is configured to utilize one or more of light source 360, light source 364, light source 368, actuator 370, display 372 or switch 374 to modify the configuration of keyboard 324 based upon input received through input 329. Controller 326, depending upon a mode selected by a user, generate control signals to actuate one or more of light source 360, light source 364, light source 368, actuator 370, display 372 or switch 374 to distinguish those keys 350 that are assigned to graphical user interfaces from those keys that are not assigned to graphical user interfaces. In some implementations, controller 326 may additionally generate control signals to distinguish different GUI assigned keys from one another, correlating or linking the different GUI assigned keys to their associated graphical user interfaces.

Input 329 comprises a device by which controller 326 receives an indication from a user as to which of the various mechanisms for modifying the configuration of keyboard 324 are to be employed. In one implementation, input 329 comprises a pushbutton, toggle, switch, slider bar, touchscreen, touchpad, speech recognition software with an associated microphone or the like. In one implementation, input 329 may be incorporated as part of keyboard 324, wherein the selected mode of operation for keyboard control system 320 is made using keyboard 324.

FIG. 6 is a top view of keyboard 324. In the example mode shown in FIG. 6, multiple modes are concurrently utilized to distinguish key 350 from other keys based upon whether or not key 350 has been assigned to a graphical user interface and based upon which of the graphical user interfaces key 350 has been assigned. In the example, key 350 is highlighted by light emitted by illumination panel 366, wherein the light has characteristics similar to the light also being emitted by illumination panel 366 of other keys 350 which have also been assigned to the graphical user interfaces 228 being presented at the moment on the display screen 22. Illumination panels 366 of those keys 350 of keyboard 324 which are not assigned to a graphical user interface 328 either do not emit light or emit light differently. Key 350 is further highlighted by the light emitted by illumination line 362. In the example, the light emitted by illumination line 360 is different (in color, intensity, pulse frequency or the like) from the light emitted by illumination panel 366 and also from any light (if any) emitted by the illumination panel 366 of keys 350 not assigned to a graphical user interface. In one implementation, the light emitted by illumination line 360 has a characteristic (color, intensity, pulse frequency or the like) corresponding to the same characteristic of the graphical user interface 2282 which key 350 has been assigned. As a result, illumination panel 366 generally distinguishes assigned keys 350 from unassigned keys 250 while illumination line 362 links particular keys 352 particular graphical user interfaces 228. In some implementations, display 372 may present a graphic or symbol 380 or light source 360 may additionally backlight key 350. Such additional highlighting may be performed by controller 3262 indicate other groupings or other characteristics of the function associated with the selection of key 350 when the particular display of graphical user interface 228 is currently being presented on screen 22. In some implementations, actuator 370 and switch 374 may further be utilized in conjunction with light sources 364, 368 and display 372 to further accentuate those keys that have been assigned to graphical user interfaces from those that are not.

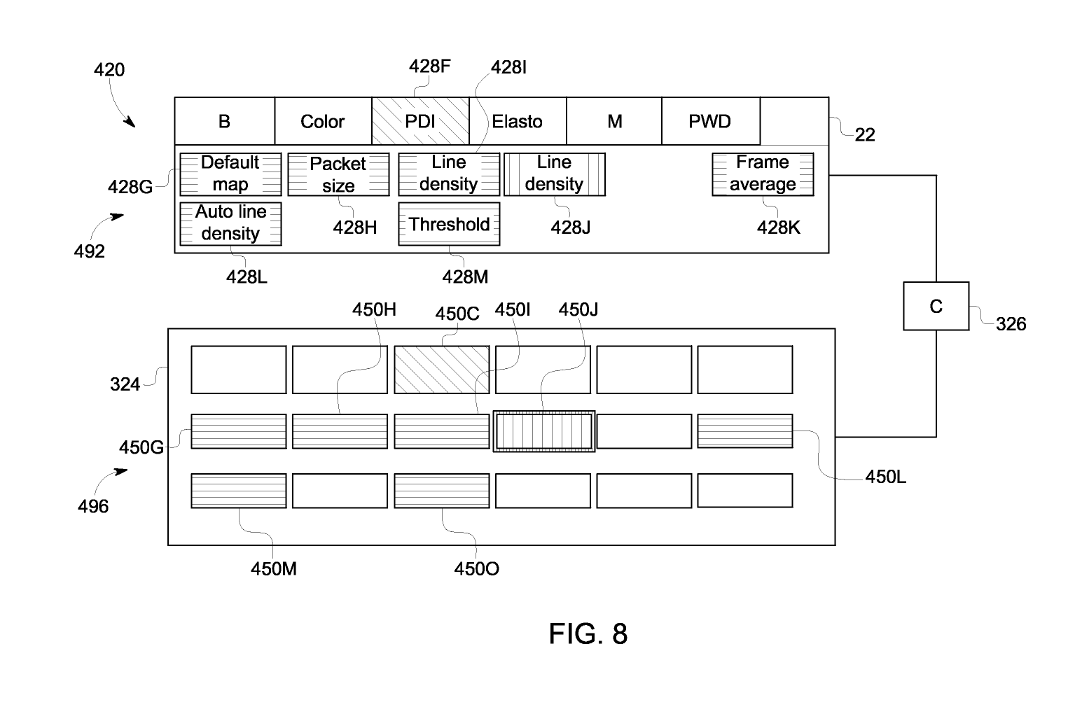

FIGS. 7-8 illustrate keyboard control system 420, an example implementation of keyboard control system 320. Keyboard control system 420 is similar to keyboard control system 320 except the keyboard control system 220 specifically comprises keys 450 for keys 350. Keys 450 are similar to keys 350 but for having the specific illustrated example shapes and the example fixed layout or pattern. In the example illustrated, keyboard 324 comprises a 6×3 array or grid of keys 450. In other implementations, keyboard 324 may have differently sized differently shaped keys in a same or different pattern. Keyboard 324 may have a greater or fewer of such keys 450.

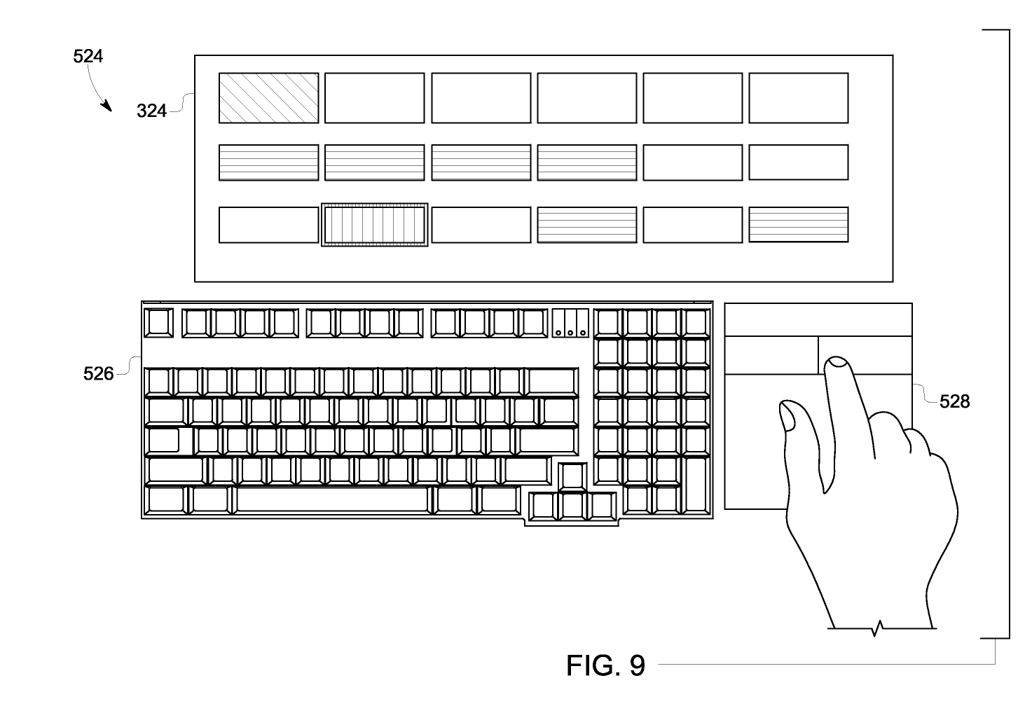

FIGS. 8 and 9 illustrate keyboard control system 420 operating in a mode selected by a person in which those keys 450 assigned to a graphical user interface are backlit by light source 360 (shown in FIG. 5) of those keys 450 not assigned to a graphical user interface are not backlit by light source 360. Those keys 450 that are assigned to a graphical user interface are distinguished from at least some of the other keys assigned to graphical user interfaces by the color of light emitted by light source 360, wherein the different colors of light emitted by light source 360 through each key corresponds to the color of the particular assigned graphical user interface 428. In the example illustrated, the other modes for modifying the configuration of keyboard 324 (using light source 364, light source 368, actuator 370, display 372 and switch 374) are not being utilized. In some implementations, such additional modes and associated componentry may be omitted from keyboard 324.

FIGS. 7 and 8 illustrate one example pair of displays 490, 492 and associated keyboard configurations 494, 496 produced by keyboard control system 420. As shown by FIG. 7, display 490 comprises graphical user interfaces 428A, 428B, 428C, 428D, 428F, 428G and 428H (collectively referred to as graphical user interfaces 428 of display 490). Each of such graphical user interfaces 428 of display 490 have shapes corresponding to at least one of keys 450 of keyboard 324. Each of graphical user interface 428 of display 490 has a color different from at least one other of graphical user interfaces 428 of display 490. In the example illustrated, graphical user interfaces 428 of display 490 and colors based upon her functional groupings of similar functions. For example in one implementation, graphical user interface 428A is green, while graphical user interfaces 428B, 428C, 428D, 428E, 428G and 428H are blue and while graphical user interface 428G is yellow. Each of such graphical user interfaces 428 of display 490 has a distinct textual label identifying the function represented by the graphical user interface.

Based upon the layout of graphical user interfaces 428 of display 490, controller 326 assigned keys 450 of configuration 494 to the graphical user interfaces 428 such that the layout or pattern of the assigned keys 450 mimics the layout or pattern of the graphical user interface 428 of display 490. In particular, key 450A is assigned to key 428A and keys 450G, 450H, 450I and 450J are assigned to graphical user interface 428B, 428C, 428D and 428E, respectively. Keys 450N, 450P and 450R are assigned to graphical user interfaces 428F, 428G and 428H, respectively.

As further shown by FIG. 7, controller 326 additionally highlights and distinguishes those keys 450 which have been assigned to graphical user interfaces 428 of display 490 from those keys 450 that is not been assigned to any graphical user interfaces 428 of display 490. In particular, those keys that are assigned are backlit by light source 360 (shown in FIG. 5). In the example illustrated, controller 326 further generates control signals causing the assigned keys of configuration 494 to be further illuminated or backlit with colors corresponding to the colors of the graphic user interfaces to which they are assigned. For example, both key 450A and graphical user interface 428A have the same color (or substantially the same color-shades may vary). Keys 450G, 450H, 450I, 450J, 450P and 450R and their associated graphical user interfaces 428B, 428C, 428D, 428E, 428G and 428H, respectively, have the same color. Lastly, key 450N and its assigned graphical user interface 428F have the same color. As a result, keyboard control system 420 facilitates easier location of those keys 450 of keyboard 324 that are been assigned to graphical user interface 428 of display 490.

FIG. 8 illustrates keyboard control system 420 when the application or program presents a modified or different display 492 on screen 22, presenting a different layout and different combination of graphical user interfaces 428. As shown by 8, display 492 comprises graphical user interfaces 428F, 428G, 428H, 428I, 428J, 428K, 428L and 428M (collectively referred to as graphical user interfaces 428 of display 492). Each of such graphical user interfaces 428 of display 492 have shapes corresponding to at least one of keys 450 of keyboard 324. Each of graphical user interface 428 of display 492 has a color different from at least one other of graphical user interfaces 428 of display 492. In the example illustrated, graphical user interfaces 428 of display 492 have colors based upon groupings of similar functions. For example in one implementation, graphical user interface 428F is green, while graphical user interfaces 428G, 428H, 428I, 428K, 428L and 428M are blue and while graphical user interface 428J is yellow. Each of such graphical user interfaces 428 of display 492 has a distinct textual label identifying the function represented by the graphical user interface.

Based upon the layout of graphical user interfaces 428 of display 490, controller 326 assigned keys 450 of configuration 496 to the graphical user interfaces 428 such that the layout or pattern of the assigned keys 450 mimics the layout or pattern of the graphical user interface 428 of display 492. In particular, key 450C is assigned to graphical user interface 428F, keys 450G, 450H, 450I, 450J AND 450L are assigned to graphical user interfaces 428G, 428H, 428I, 428J and 428K, respectively. Keys 450M and 4500 are assigned to graphical user interfaces 428Land 428M, respectively.

As further shown by FIG. 8, controller 326 additionally highlights and distinguishes those keys 450 which have been assigned to graphical user interfaces 428 of display 492 from those keys 450 that have not been assigned to any graphical user interfaces 428 of display 492. In particular, those keys that are assigned to a presently presented graphical user interface are backlit by light source 360 (shown in FIG. 5). In the example illustrated, controller 326 further generate control signals causing the assigned keys of configuration 496 to be further illuminated or backlit with colors corresponding to the colors of the graphic user interfaces to which they are assigned. For example, both key 450C and graphical user interface 428F have the same color (or substantially the same color-shades may vary). Keys 450G, 450H, 450I, 450L, 450M and 4500 and their associated graphical user interfaces 428G, 428H, 428I, 428K, 428L and 428M, respectively, have the same color. Lastly, key 450J and its assigned graphical user interface 428J have the same color. As a result, keyboard control system 420 facilitates easier location of those keys 450 of keyboard 324 that have been assigned to graphical user interface 428 of display 492.

FIG. 9 illustrates keyboard 524, an example of a keyboard that may be employed in keyboard control systems 20, 220 420. In addition to keyboard 324, keyboard 524 additionally comprises a QWERTY keyboard 526 and a touchpad or trackpad 528. Keyboard 526 and touchpad 528 provide additional input mechanisms. In some implementations, keyboard 526 may be additionally provided with one or more of those mechanisms shown and described above with respect of FIG. 5 facilitating modification of the configuration of keyboard 526 based upon modifications to the display of graphical user interfaces on display screen 22. Although keyboard 324 is shown in FIG. 9 is having configuration 494, controller 326 may modify the configuration based upon new displays of graphical user interfaces 428.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a display screen;
a physical keyboard; and
a controller to generate and transmit control signals to the physical keyboard to modify at least one physical configuration characteristic of the physical keyboard based on modifications to display of the one or more graphical user interfaces on the display screen.

2. The apparatus of claim 1, wherein the one or more graphical user interfaces comprises multiple graphical user interfaces presented in a layout on the display screen, wherein the physical keyboard has keys, wherein the control signals assign the keys to the multiple graphical user interfaces such that the keys assigned to the multiple graphical user interfaces have a key layout corresponding to the layout of the multiple graphical user interfaces.

3. The apparatus of claim 2, wherein the control signals highlight the keys assigned to the multiple graphical user interfaces.

4. The apparatus of claim 3, wherein the control signals highlight the selected keys by causing the selected keys to be backlit differently from non-selected keys.

5. The apparatus of claim 4, wherein the non-selected keys are not backlit.

6. The apparatus of claim 4, wherein the selected keys are backlit with a first non-zero intensity and the non-selected keys are backlit with a second non-zero intensity different than the first non-zero intensity.

7. The apparatus of claim 4, wherein the selected keys are backlit with a first non-zero pulse frequency and wherein the non-selected keys are backlit with a second non-zero pulse frequency different than the first non-zero pulse frequency.

8. The apparatus of claim 4, wherein the selected keys are backlit with a first color and wherein the non-selected keys are backlit with a second color.

9. The apparatus of claim 8, wherein the graphical user interfaces corresponding to the selected keys have the first color.

10. The apparatus of claim 4, wherein the second control signals highlight the selected keys by associating colors with the selected keys, wherein non-selected keys are associated with different colors.

11. The apparatus of claim 3, wherein the control signals highlight the selected keys by associating colors with the selected keys, wherein non-selected keys are associated with different colors.

12. The apparatus of claim 3, wherein the control signals highlight the selected keys by highlighting regions surrounding the selected keys.

13. The apparatus of claim 3, wherein the control signals highlight the selected keys by highlighting sets of the keys such that the keys of each set have at least one same physical characteristic different from non-selected keys and different from the selected keys of other sets.

14. The apparatus of claim 8, wherein the control signals highlight the selected keys by backlighting the regions surrounding the selected keys differently from non-selected keys.

15. The apparatus of claim 10, wherein the non-select keys are not backlit.

16. The apparatus of claim 8, wherein the graphical user interfaces comprise symbols and wherein the control signals change keys corresponding to the graphical user interfaces to present symbols corresponding to the symbols of the corresponding graphical user interfaces.

17. The apparatus of claim 1, wherein the display screen comprises a touchscreen.

18. The apparatus of claim 1, wherein the physical keyboard further comprises a QWERTY set of keys.

19. The apparatus of claim 1, wherein the graphical user interfaces having shapes and sizes corresponding to the corresponding keys of the physical keyboard.

20. The apparatus of claim 1, wherein the physical keyboard has keys, wherein the control signals generated and transmitted to the physical keyboard highlight one of the keys corresponding to the graphical user interface presently being presented on the display screen.

21. The apparatus of claim 1, wherein the at least one configuration characteristic of the physical keyboard modified by the control signals is selected from a group of physical configuration characteristics consisting of: backlighting, pressure sensitivity, lock-out rigidity, and raising and lowering of one or more keys.

22. An apparatus comprising:
a non-transient computer-readable medium comprising code to direct a processing unit to:
modify at least one physical characteristic of a physical keyboard based on a modification to a display of one or more graphical user interfaces on a display screen.

23. A method comprising:
modifying display of one or more graphical user interfaces on a display screen; and
modifying at least one physical characteristic of a physical keyboard based on the modification of the display of the one or more graphical user interfaces on the display screen.
